(19) United States
(12) Patent Application Publication
(10) Pub. No.: US 2019/0269080 A1
(43) Pub. Date: Sep. 5, 2019

(54) Hydroponic Tower Compatible Plant Container

(71) Applicant: MJNN, LLC, South San Francisco, CA (US)

(72) Inventors: John Whitworth, Mountain View, CA (US); Loren Pilorin, Palo Alto, CA (US); Taylor Brooke Wollert, Lingle, WY (US); Michael Flynn, Palo Alto, CA (US); Alexandre Le Roux, Menlo Park, CA (US); Damon Henry Smith, Laramie, WY (US); Mark Cuson, Los Altos, CA (US)

(73) Assignee: MJNN, LLC, South San Francisco, CA (US)

(21) Appl. No.: 15/910,308

(22) Filed: Mar. 2, 2018

(51) Int. Cl. A01G 31/06; A01G 27/06

(52) U.S. Cl. CPC A01G 31/06; A01G 27/06

(57) ABSTRACT

A plant container is provided which is designed to be inserted within the slot of a hydroponic tower, where the hydroponic tower includes both a matrix media and a moisture and nutrient transport system (e.g., a wicking strip). The plant container includes (i) a plant cup configured to hold a plant's root structure along with a small portion of plant growth media; (ii) an insertion blade that insures that as the plant container is inserted into the hydroponic tower slot, the matrix media and the associated wicking strips are pushed to either side of the plant cup; and (iii) a handling member that aids container insertion and removal, and which may include an alignment surface that insures that the plant container is fully inserted and aligned during the insertion procedure.

### FIELD OF THE INVENTION

The present invention relates generally to hydroponic growing systems and, more particularly, to a plant container configured to simplify and expedite the insertion and removal of plants within a hydroponic tower.

### BACKGROUND OF THE INVENTION

The continued growth of the world's population is increasingly taxing the ability of conventional farms to adequately feed everyone. In an attempt to ease this crisis, in recent decades there has been an increased use of pesticides and fertilizers. Unfortunately this dependence on pesticides and fertilizers has exacerbated the problem, leading to regions that are less favorable to farming and, in some instances, creating dead zones in waterways subject to runoff.

Since population centers and agricultural centers are frequently not co-located, and due to the time and expense associated with shipping agricultural goods, in many regions of the world only the wealthy are able to obtain adequate supplies of non-processed food, i.e., raw fruits and vegetables. Furthermore, the fruits and vegetables that do reach population centers are likely to be of decreased nutritional content and flavor, both due to the distance that they have traveled and the fact that much of today's produce is bred for durability and fertility rather than flavor & nutrition. As a result, there has been a renewed interest in soilless growing techniques that do not require the use of pesticides, drastically reduce the use of water, and allow for growing varietals that are bred for nutrition and flavor instead of durability.

Hydroponics is a soilless growing technique in which plants are grown using a liquid solution of water and nutrients. The roots of the plants are typically maintained in a fibrous or granular material, often comprised of plastic, and fed via a wick, drip, nutrient film, or other nutrient delivery system. Hydroponic growing systems are often established within indoor facilities, thus allowing them to be located in or near population centers. This approach also provides exceptional climate control (i.e., temperature, humidity, air flow, CO₂ concentration, light wavelength, intensity and duration, etc.) as well as improved pest and disease control, thus allowing an indoor hydroponic farm to succeed in a region in which the outside environment and/or the soil conditions are inhospitable to the use of conventional farming techniques. Furthermore, hydroponic and other soilless growing techniques can yield extremely high plant densities, especially in those instances in which either horizontal stacking systems or vertical growth towers are used.

While hydroponic farming techniques offer a number of advantages over conventional farming techniques, in order to achieve large-scale adoption of these techniques it is vital that the cost per plant be competitive with the costs associated with conventional farming techniques. Accordingly, the present invention provides a means of simplifying and expediting the process by which plants may be inserted and/or removed from a hydroponic tower.

### SUMMARY OF THE INVENTION

The present invention provides a plant container configured to be inserted within a slot in a hydroponic tower, where the hydroponic tower includes both matrix media (e.g., a fibrous material composed of plastic) and a wicking strip. The plant container is comprised of (i) a plant cup, (ii) an insertion blade, and (iii) a handling member. The plant container, which may be fabricated as a single unit, is preferably fabricated from a plastic material.

The plant cup is configured to contain a plant root structure as well as a growth medium. Once the plant container is fully inserted into the tower, the plant cup's central axis is angled upwards to aid plant growth, where the angle is preferably in the range of 30 to 60 degrees off horizontal; more preferably where the angle is in the range of 40 to 50 degrees off horizontal; and still more preferably where the angle is set at approximately 45 degrees off horizontal. The front open face of the plant cup is proximate to the front surface of the hydroponic tower when the plant container is fully inserted into the tower's slot. More specifically, the front open face of the plant cup may be (i) recessed relative to the tower's front surface, (ii) extending outward and beyond the tower's front surface, or (iii) flush with the tower's front surface.

At least one side of the plant cup contains one or more openings in order to allow water and nutrients transported by the wicking strip(s) to (i) reach the roots contained within the plant cup, (ii) prevent excessive pooling of water/nutrients within the plant cup, and (iii) provide space for the roots to grow out towards the open space within the tower. Preferably two or more sides of the plant cup include one or more openings. The openings may be oval-shaped, polygonal-shaped, or otherwise shaped.

The insertion blade, which is preferably solid and less than 0.25 inches thick, extends from the rear portion of the plant cup. This blade is designed to insure that as the plant container is inserted into the hydroponic tower slot, the matrix media and the associated wicking strips are pushed to either side of the plant cup rather than being pushed towards the rear of the tower. If the matrix media and the wicking strips are allowed to be pushed to the back of the tower, the plant contained within the plant cup is unlikely to receive sufficient water and nutrients. In addition to extending from the rear portion of the plant cup, the insertion blade may also extend from the upper and/or lower portion of the plant cup. Preferably the rearmost edge of the insertion blade is in contact with the inner rear surface of the tower when the plant container is fully inserted into the tower's slot.

The plant container includes at least one, and preferably a pair of handling members proximate to the plant cup's open front face. The handling member(s), which extends from the side(s) of the plant cup, includes one or more gripping surfaces that provide the user with a readily accessible handle to use during container insertion and removal. As such, the gripping surface(s) extends away from the tower's front surface even when the plant container is fully inserted into the tower's slot. Preferably the handling member(s) also includes an alignment surface that lies flat against the front surface of the hydroponic tower when the plant container is fully inserted into the tower's slot.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. 1 provides a perspective view of an exemplary hydroponic tower for use with the plant container of the invention;

FIG. 2 provides a perspective view of the tower shown in FIG. 1 with the inclusion of the matrix media strips;

FIG. 3 provides a perspective view of a second exemplary hydroponic tower for use with the plant container of the invention;

FIG. 4 provides a perspective view of the tower shown in FIG. 3 with the inclusion of the matrix media strips;

FIG. 5 provides a perspective view of a preferred embodiment of a plant container in accordance with the invention;

FIG. 6 provides a second perspective view of the preferred embodiment of the plant container shown in FIG. 5;

FIG. 7 provides a top view of the plant container shown in FIGS. 5 and 6;

FIG. 8 provides a side view of the plant container shown in FIGS. 5-7;

FIG. 9 provides a front view of the plant container shown in FIGS. 5-8; and

FIG. 10 provides a perspective view of a second embodiment of a plant container in accordance with the invention.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, process steps, operations, elements, and/or components, but do not preclude the presence or addition of one or more other features, process steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps, calculations, or components, these steps, calculations, or components should not be limited by these terms, rather these terms are only used to distinguish one step, calculation, or component from another. For example, a first calculation could be termed a second calculation, and, similarly, a first step could be termed a second step, and, similarly, a first component could be termed a second component, without departing from the scope of this disclosure.

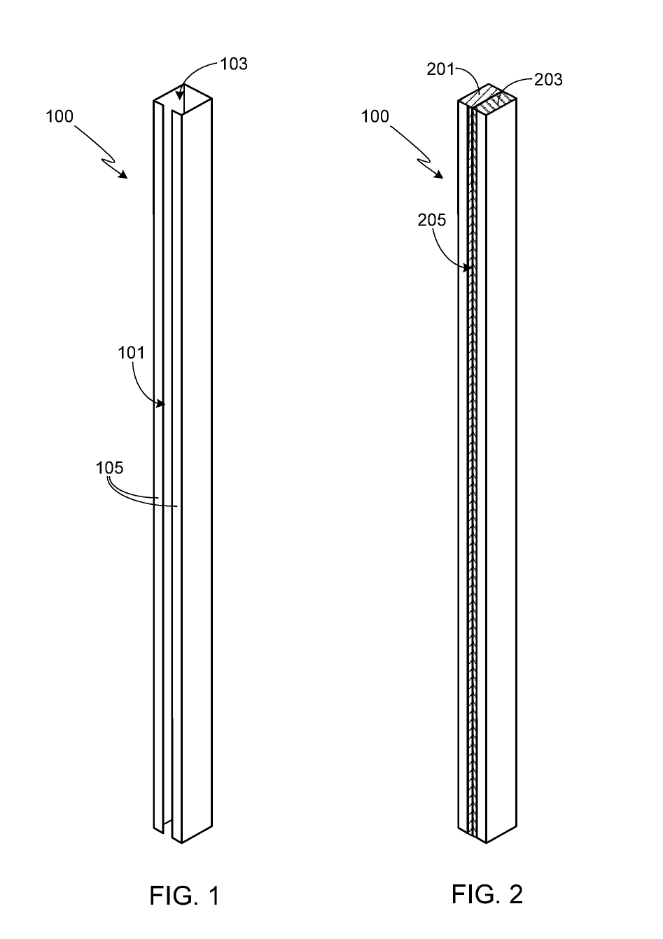

FIG. 1 provides a perspective view of an exemplary hydroponic tower 100. Tower 100 is preferably extruded, although other fabrication techniques may be used in its manufacture. Preferably tower 100 is fabricated from plastic (e.g., polyethylene, polypropylene, polyvinyl chloride, polytetrafluoroethylene, etc.), although it can also be fabricated from metal (e.g., aluminum) or other material. As fabricated, the tower is hollow and preferably, although not necessarily, utilizes a square cross-section as shown. The cross-section of the exemplary tower is 4 inches by 4 inches, although the invention is equally applicable to towers of other dimensions (e.g., 3×3 inches, 2×2 inches, etc.) and other configurations (e.g., 5 inches wide by 3 inches deep, tapered walls, etc.). Typical tower heights range from 6 feet to 10 feet, although other heights may be used. In general, the height selected for a particular hydroponic tower is based on (i) the size of the facility housing the tower, (ii) the means used to access the tower during planting, plant monitoring and harvesting, and (iii) achieving the desired level of consistency in plant growth throughout the entire tower.

The front surface of tower 100 includes a slot 101. Slot 101 is of sufficient width to allow access for planting while still being small enough to hold the matrix media, described below, within the tower. Preferably the width of slot 101 is selected to be within the range of 0.75 to 1.25 inches.

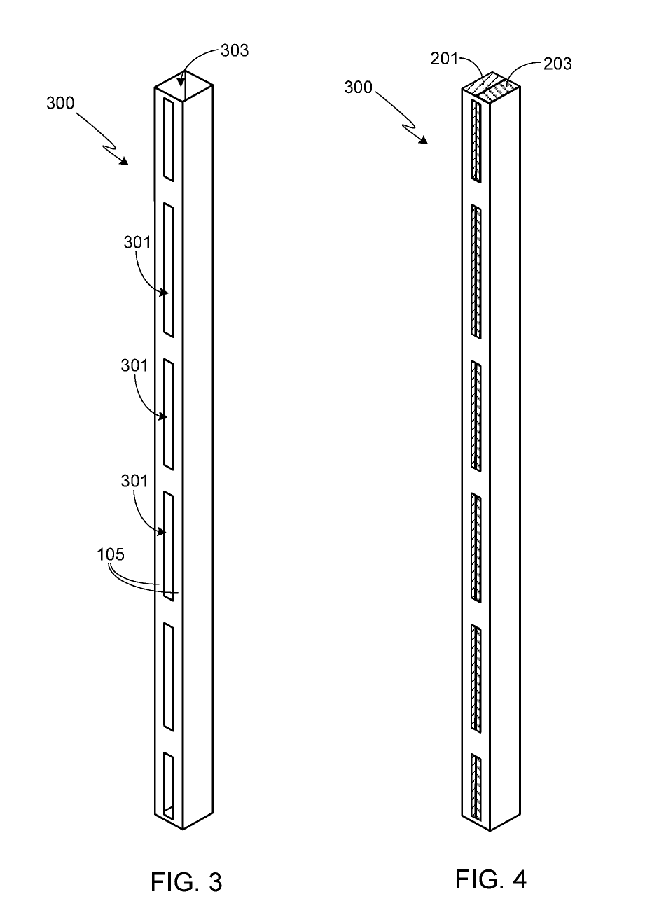

In the embodiment shown in FIGS. 1 and 2, slot 101 is a continuous slot running from the top of the tower to the bottom of the tower. This approach simplifies tower fabrication while insuring maximum flexibility for plant placement and plant spacing. It should be understood, however, that a continuous slot is not required by the invention. For example, rather than a continuous slot, the hydroponic tower can utilize a series of slots 301 as illustrated in tower 300 shown in FIGS. 3 and 4.

Located within the hollow portion of the hydroponic tower, e.g., portion 103 in tower 100 and portion 303 in tower 300, is a matrix growth media, also referred to herein as a matrix media. The matrix growth media, which is preferably fabricated from a fibrous material such as a fibrous plastic material, holds the plant containers described below in place within the tower. The matrix material also provides a support system for plant roots that extend out of the individual plant containers. Additionally, the matrix media helps to capture moisture and nutrients.

As illustrated in FIGS. 2 and 4, the matrix media is typically inserted into the tower as two strips 201 and 203, with the division 205 between the strips being located along the centerline of slot 101 (or slots 301). While various techniques may be used to direct water and nutrients to the plants contained within the hydroponic tower, in the preferred embodiment a wicking material is used to transport moisture and nutrients along the tower to the plants contained in the individual plant containers described below. The wicking medium is wrapped around at least a portion of at least one of the matrix media strips, and preferably around at least a portion of each of the media strips. Assuming a layer of wicking material is applied to both media strips, the layer of wicking material applied to media strip 201 and the layer of wicking material applied to media strip 203 are adjacent to one another, i.e., at the junction of the two media strips, and run along the length of the tower slot or slots, thus insuring that water and nutrients reach each of the plant containers inserted into the tower slot(s).

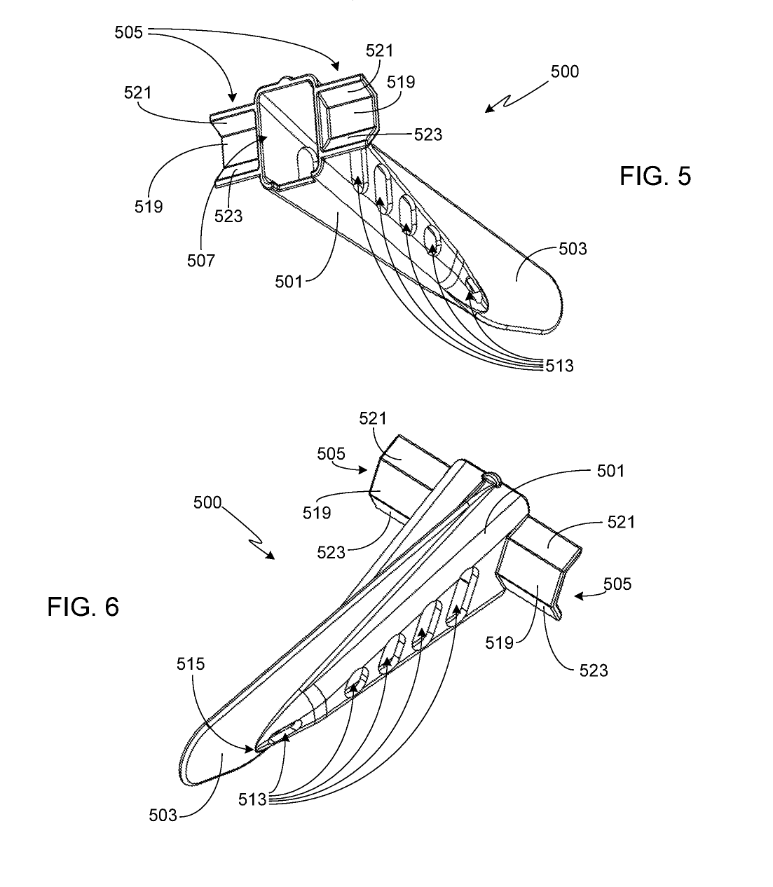

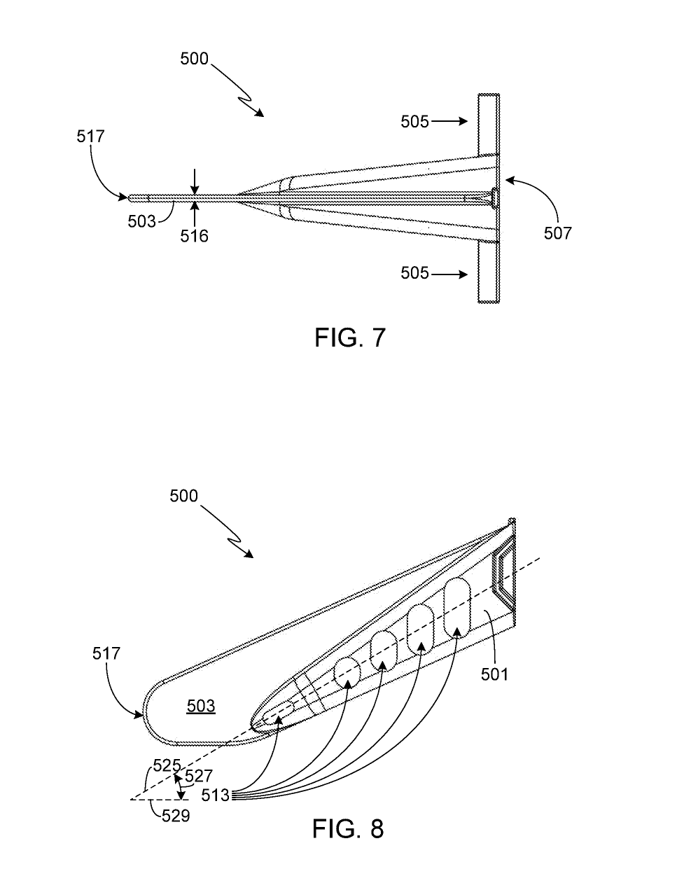

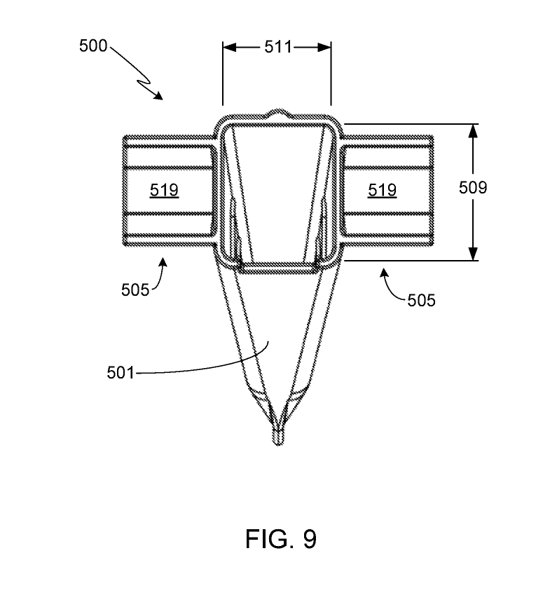

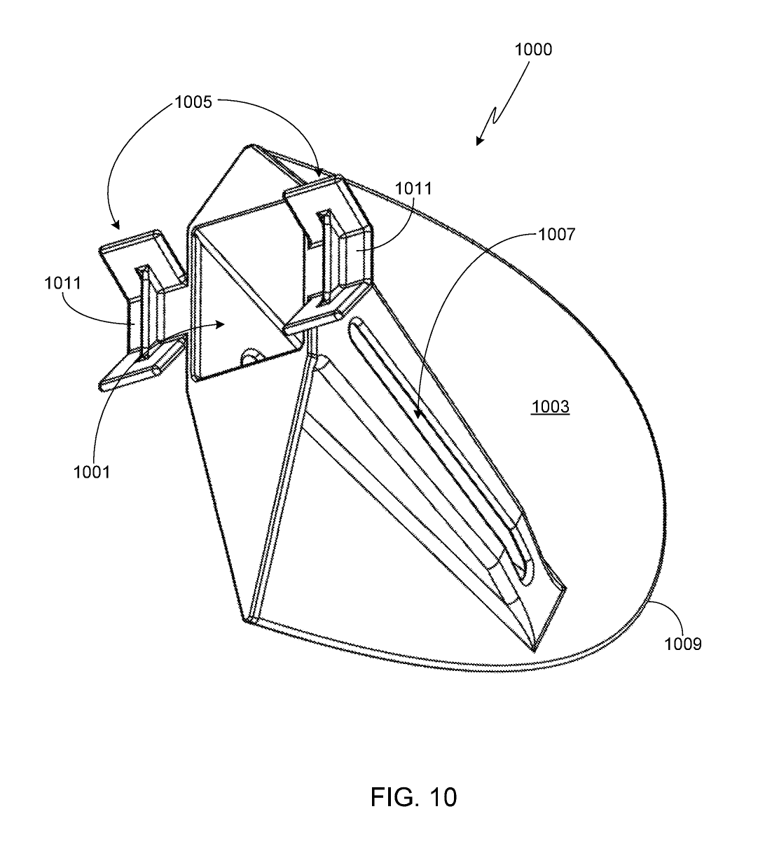

FIGS. 5 and 6 provide prospective views of a preferred embodiment of a plant container 500. FIGS. 7-9 provide top, side and front views, respectively, of the same plant container. In accordance with the invention, each plant container is comprised of three primary sections, specifically (i) a plant cup 501, (ii) an insertion blade 503, and (iii) one or more handling members 505. Preferably each plant container 500 is fabricated, for example by injection molding, as a single piece and manufactured from plastic (e.g., polyethylene, polypropylene, polyvinyl chloride, polytetrafluoroethylene, acrylonitrile butadiene styrene (ABS), etc.). Plastic is the preferred material due to material cost, fabrication cost and final component weight, although it should be understood that the plant container can be fabricated using other techniques and materials (e.g., metal, biodegradable materials, etc.). In the preferred embodiment, the plastic material used for the plant container is colored white in order to increase the amount of light reflected back onto the plants.

Plant cup 501 is configured to hold a plant, specifically a plant's root structure, along with a small portion of plant growth media (e.g., soil, coconut coir, etc.). When the plant container 500 is mounted within the slot of a hydroponic tower (e.g., slot 101 of tower 100 or slots 301 of tower 300), preferably the front face 507 of cup 501 extends slightly out and away from the front surface of the tower (e.g., surface 105 of the hydroponic tower). Generally front face 507 extends out from the front tower face by less than 1 inch, preferably less than 0.5 inches, and more preferably less than 0.25 inches. It will be appreciated, however, that plant cup 501 may be configured such that front face 507 is flush with the front tower surface when the plant container is mounted within the tower; alternately, plant cup 501 may be configured such that front face 507 is recessed, i.e., extending inwardly from the front tower face, when the plant container is mounted within the tower.

The size of the opening in the front face 507 of plant cup 501 is determined, at least in part, by the width of the hydroponic tower slot(s) into which the plant container is configured to fit. The inventors have found that it is generally desirable to have an opening that is less than 2 inches in either dimension (i.e., opening height 509 and opening width 511), and preferable to have an opening that is 1 inch or less in both height and width. In the embodiment illustrated in FIGS. 5-9, the opening of plant cup 501 is 0.75 inches by 0.75 inches.

As shown in the figures, both sides of plant cup 501 are partially open, thus allowing water and nutrients transported by the wicking layer(s) to feed the contained plant via the root structure. These same holes simplify plant container cleaning between plantings. In the illustrated embodiment, openings 513 located on either side of plant cup 501 are generally oval-shaped, although it should be understood that the openings may utilize other shapes (e.g., circular, polygonal).

Extending from the rear-most portion 515 of plant cup 501 is insertion blade 503. In this embodiment, insertion blade 503 also extends upwards from the top-most portion of plant cup 501. Preferably insertion blade 503 is solid with a thickness 516 of less than 0.25 inches, and more preferably with a thickness of approximately 0.125 inches. Insertion blade 503 insures that as the plant container 100 is inserted into the hydroponic tower slot(s), matrix media 201/203 and the associated wicking strips are pushed to either side of the plant cup 501. Without the inclusion of insertion blade 503, the matrix media and the associated wicking strips may be pushed towards the rear of the tower when the plant container is inserted into the hydroponic tower slot(s). If this is allowed to occur, the plant is unlikely to receive sufficient water and nutrients via the wicking strips, leading to plant stress and eventual plant death. The insertion blade may also include features, e.g., barbs, which lock into the matrix media during insertion, thus helping to prevent the plant container from gradually being pushed out of the tower by the roots of the growing plant.

In addition to pushing the matrix media and wicking strips aside during plant container insertion, the insertion blade 503 may also be sized so that when the plant container is fully inserted into the tower, the rear edge 517 of the blade rests against the rear inner surface of the tower. This prevents the plant container from being pushed too far into the tower slot, and instead provides positive feedback that the container has been properly located within the slot. Note that in the preferred embodiment, insertion blade 503 is located along the plant container's centerline as shown, thus properly placing the plant container between the matrix media strips and the layers of wicking material.

Located on at least one side of the plant container, and preferably located on both sides of the plant container, are handling members 505. The handling members simplify both insertion and removal of the plant container by providing a readily accessible handle for the user to grip. Preferably each handling member 505 includes a flat surface 519 that is designed to lay flat against tower surfaces 105 when the plant container is properly located within the tower, thus providing a depth gauge during container insertion. Additionally, by requiring that surface(s) 519 lie flat against the tower face when the container is properly positioned, handling member(s) 505 insures that the plant cup 501 is at the desired angle. When the plant container is properly located within the hydroponic tower, the central axis 525 of plant cup 501 is at an angle 527 off of the horizontal (represented by line 529), preferably where the angle is in the range of 30 to 60 degrees, more preferably at an angle off horizontal in the range of 40 to 50 degrees, and still more preferably at an angle of 45 degrees off horizontal.

In addition to including alignment surface 519, each handling member 505 also includes at least one gripping surface 521, and preferably a pair of gripping surfaces 521/523. Surfaces 521/523 are angled outwardly from alignment surface 519 as shown, thus insuring that even when the plant container is fully inserted into the hydroponic tower, the handle members are still easily accessible and easily graspable via the gripping surfaces. Additionally, these faces are orientated such that applying an upward force on them results in the inserts sliding out of the tower.

FIG. 10 provides a prospective view of a second embodiment of a plant container. Plant container 1000 includes the same primary features as plant container 500, specifically (i) a plant cup 1001, (ii) an insertion blade 1003, and (iii) one or more handling members 1005. As a result of these similarities, plant containers 500 and 1000 perform in the same way and provide comparable functionality. Preferably plant container 1000 is also fabricated from plastic using injection molding techniques.

While the basic configuration of plant cup 1001 is similar to that of plant cup 501, this embodiment utilizes a single elongated opening 1007 on either side of the cup as shown. Openings 1007 allow water and nutrients that are transported by the wicking layers to reach the plant's root structure. When properly located within the tower, preferably the plant cup is at the desired angle, i.e., preferably within the range of 30 to 60 degrees off horizontal, more preferably within the range of 40 to 50 degrees off horizontal, and still more preferably at an angle of 45 degrees off horizontal.

The most noticeable difference between plant containers 500 and 1000 is in the design of the insertion blade. As shown, in this embodiment insertion blade 1003 not only extends from the rear-most portion of the plant cup, but also both above and below the plant cup. By enlarging the size of the insertion blade, the rear-most portion 1009 of the blade has a very gradual curvature, thereby further minimizing the risk of the plant container pushing the matrix media towards the rear of the tower during plant container insertion into the hydroponic tower slot(s). As in the prior embodiment, at least one, and preferably two, handling members 1005 simplify container handling during insertion and removal. Additionally, and as with the previously described embodiment, the inclusion of alignment surfaces 1011 insure that the plant container can be quickly positioned within the tower, both in terms of insertion depth and plant cup angular orientation.

In addition to providing a convenient means for inserting and removing plants in a hydroponic tower, it should be understood that the plant containers of the present invention can also be used to locate any of a variety of sensors within the tower. In such a scenario, a suitable sensor rather than a plant and soil is placed within the container's plant cup, thus allowing a variety of growing conditions to be monitored (e.g., moisture levels, nutrient concentrations, etc.).

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. A plant container configured to be inserted within a slot in a hydroponic tower, wherein the hydroponic tower includes a matrix media and a wicking strip, the plant container comprising:
a plant cup configured to contain a plant root structure and a growth medium, wherein a central axis corresponding to said plant cup is angled upwards at an angle off horizontal when the plant container is fully inserted into the slot of the hydroponic tower, said plant cup comprising:
an open front face, wherein said open front face of said plant cup is proximate to a front surface of said hydroponic tower when the plant container is fully inserted into the slot of the hydroponic tower;
a rear portion distal from said open front face; and
at least one opening within at least one side surface of said plant cup, said at least one opening configured to allow passage of a water/nutrient mix transported by said wicking strip to said plant root structure contained within said plant cup;
an insertion blade extending from said rear portion of said plant cup, said insertion blade configured to push aside the matrix media and the wicking strip during insertion of the plant container into the slot of the hydroponic tower; and
a handling rail proximate to said open front face and extending from a first side surface of said plant cup, said handling rail comprising a first gripping surface, wherein said first gripping surface extends away from said front surface of said hydroponic tower when the plant container is fully inserted into the slot of the hydroponic tower.

2. The plant container of claim 1, said handling rail further comprising an alignment surface, wherein said alignment surface lies flat against said front surface of said hydroponic tower when the plant container is fully inserted into the slot of the hydroponic tower.

3. The plant container of claim 2, said handling rail further comprising a second gripping surface, wherein said second gripping surface extends away from said front surface of said hydroponic tower when the plant container is fully inserted into the slot of the hydroponic tower, and wherein said first gripping surface is coupled to an upper edge of said alignment surface and said second gripping surface is coupled to a lower edge of said alignment surface.

4. The plant container of claim 3, further comprising a second handling rail, said second handling rail proximate to said open front face and extending from a second side surface of said plant cup, said second handling rail comprising a third gripping surface, a fourth gripping surface and a second alignment surface, wherein said second alignment surface lies flat against a second front surface of said hydroponic tower when the plant container is fully inserted into the slot of the hydroponic tower, wherein said third gripping surface and said fourth gripping surface extend away from said second front surface of said hydroponic tower when the plant container is fully inserted into the slot of the hydroponic tower, and wherein said third gripping surface is coupled to an upper edge of said second alignment surface and said fourth gripping surface is coupled to a lower edge of said second alignment surface.

5. The plant container of claim 1, wherein said open front face of said plant cup is recessed relative to said front surface of said hydroponic tower when the plant container is fully inserted into the slot of the hydroponic tower.

6. The plant container of claim 1, wherein said open front face of said plant cup extends outward and beyond said front surface of said hydroponic tower when the plant container is fully inserted into the slot of the hydroponic tower.

7. The plant container of claim 1, wherein said open front face of said plant cup is flush with said front surface of said hydroponic tower when the plant container is fully inserted into the slot of the hydroponic tower.

8. The plant container of claim 1, said at least one opening within said at least one side surface of said plant cup further comprising at least a first opening within said first side surface of said plant cup and at least a second opening within a second side surface of said plant cup.

9. The plant container of claim 8, said first opening within said first side surface further comprising a first plurality of oval-shaped openings, and said second opening within said second side surface further comprising a second plurality of oval-shaped openings.

10. The plant container of claim 8, said first opening within said first side surface further comprising a first plurality of polygonal-shaped openings, and said second opening within said second side surface further comprising a second plurality of polygonal-shaped openings.

11. The plant container of claim 1, said insertion blade extending from an upper portion of said plant cup.

12. The plant container of claim 1, said insertion blade extending from a lower portion of said plant cup.

13. The plant container of claim 1, wherein said insertion blade is solid with a thickness of less than 0.25 inches.

14. The plant container of claim 1, wherein a rearmost edge of said insertion blade contacts an inner surface of said hydroponic tower when the plant container is fully inserted into the slot of the hydroponic tower.

15. The plant container of claim 1, wherein said angle off horizontal of said central axis of said plant cup is in the range of 30 degrees to 60 degrees.

16. The plant container of claim 15, wherein said angle off horizontal of said central axis of said plant cup is in the range of 40 degrees to 50 degrees.

17. The plant container of claim 16, wherein said angle off horizontal of said central axis of said plant cup is approximately 45 degrees.

18. The plant container of claim 1, said plant container fabricated from a plastic material.

19. The plant container of claim 1, said plant container fabricated as a single piece.

20. The plant container of claim 1, said matrix media comprised of a fibrous material composed of plastic.
